(19) United States
(12) Patent Application Publication
(10) Pub. No.: US 2024/0313285 A1
(43) Pub. Date: Sep. 19, 2024

(54) Recovery of Metals from Materials Containing Lithium and Iron

(71) Applicant: Queen's University at Kingston, Kingston, CA (US)

(72) Inventors: Ahmad Ghahreman, Kingston (CA); Harshit Mahandra, Kingston (CA); Yeonuk Choi, Toronto (CA)

(21) Appl. No.: 18/268,445

(22) PCT Filed: Dec. 17, 2021
(86) PCT No.: PCT/CA2021/051835

§ 371 Date: Jun. 20, 2023

Related U.S. Application Data
(60) Provisional application No. 63/128,222, filed on Dec. 21, 2020.

(51) Int. Cl. H01M 10/54; C01B 25/30; C01D 15/08; C01G 49/02; C22B 3/22; C22B 3/44; C22B 7/00; C22B 26/12

(52) U.S. Cl. CPC H01M 10/54; C01B 25/30; C01D 15/08; C01G 49/02; C22B 3/22; C22B 3/44; C22B 7/007; C22B 26/12

(57) ABSTRACT

Methods for recycling lithium and iron containing material, such as batteries, include selectively leaching lithium from the material by disposing the material in a powder form in a solution comprising formic acid and hydrogen peroxide, filtering the solution to obtain a first leach liquor comprising lithium and a residue comprising iron phosphate and carbon, subjecting the first leach liquor to a first precipitation to remove residual iron from the leach liquor and obtain a second leach liquor, and subjecting the second leach liquor to a second precipitation, wherein lithium is precipitated and a third leach liquor is obtained. The third leach liquor may be subjected to a third precipitation using trisodium phosphate or sodium carbonate. The material may be a battery cathode, such as a lithium iron phosphate battery cathode.

### FIELD

This invention relates to methods for recycling lithium and iron containing materials, such as batteries. More particularly, the invention relates to methods for recovering metals from lithium and iron containing material, such as lithium iron phosphate (LFP) batteries, using selective leaching of lithium and other metals from the material.

### BACKGROUND

Lithium iron phosphate (LFP) batteries are extensively used in electric vehicles (EV), hybrid electric vehicles (HEV), energy storage devices, and electronic equipment due to their favourable characteristics such as low cost, high power capacity, long life cycle, low toxicity, thermal safety, extended energy storage, and high reversibility (Li et al., 2020). The cathode material LiFePO₄ is safe to use due to low electrochemical potential, which is a significant factor in the extensive use of LFP batteries (Bain et. al. 2015; Goodenough et al., 2010).

The widespread use of LFP batteries leads to economic and environmental concern (He, et al., 2020). The economic concern is associated with lithium production required for the synthesis of LFP. Lithium reserves are abundant, but its extraction suffers from inconsistent product quality and high cost (Kavanagh et al., 2018). Selective recovery of lithium from spent batteries supports the chain of demand and supply and helps to preserve primary resources, and hence, reduces economic burden. On the other hand, there is environmental concern associated with extraction of lithium reserves and disposal of waste generated at the end of LFP battery life cycle. Improper or direct landfill disposal of spent batteries leads to solubilization of hazardous elements to the soil and ground water resulting in serious environmental issues (Jiang et al., 2016; Byeon et al., 2018). Therefore, efficient recycling of spent batteries is needed to reduce environmental burden and foster economic growth.

Direct regeneration and hydrometallurgical methods have been used for recycling of spent LFP batteries (Li et al., 2017). Direct regeneration is generally carried out by heating the material at high temperature. In a hydrometallurgical process, spent batteries are pretreated and then the scrap electrode material is leached with a suitable acid to produce a pregnant leach liquor. Later, the metal of interest is recovered using various purification methods. Mineral acids such as sulphuric acid (Li et al., 2017), hydrochloric acid (Shin et al., 2015), nitric acid (Yang et al., 2018) phosphoric acid (Bian et al., 2016) and some organic acids such as acetic acid (Yang et al., 2018), citric acid, and oxalic acid (Yang et al., 2018) have been proposed for recycling spent LFP batteries; however, none of the proposed processes meets requirements of efficiency, cost-effectiveness, and low environmental impact for commercial implementation.

### SUMMARY

One aspect of the invention relates to a method for recovering one or more metals from a lithium and iron containing material, comprising: selective leaching of lithium from the material by disposing the material in a powder form in a solution comprising formic acid at a concentration equal to or less than about 1.5 mol/L and hydrogen peroxide at a concentration equal to or less than about 10%; filtering the solution to obtain a first leach liquor comprising lithium and a residue comprising iron phosphate and carbon; subjecting the first leach liquor to a first precipitation to remove residual iron from the leach liquor and obtain a second leach liquor; subjecting the second leach liquor to a second precipitation, wherein lithium is precipitated and a third leach liquor is obtained.

In one embodiment, the method comprises subjecting the third leach liquor to a third precipitation, wherein lithium is precipitated.

In one embodiment, the first precipitation is carried out at a pH of about 8 to about 13 and a temperature up to about 100° C., wherein iron(III) hydroxide is precipitated.

In one embodiment, the first precipitation is carried out at a pH of about 9 and a temperature of about 60° C., wherein iron(III) hydroxide is precipitated.

In one embodiment, the second precipitation is carried out at a pH and a temperature higher than a pH and a temperature of the first precipitation.

In one embodiment, the second precipitation is carried out at a pH of about 11 and a temperature of about 100° C.

In one embodiment, the third precipitation is carried out at a pH and a temperature higher than a pH and a temperature of the second precipitation.

In one embodiment, third precipitation is carried out at a pH of about 12.5 and a temperature of about 100° C.

In one embodiment, the method comprises adding trisodium phosphate to the third leach liquor for the third precipitation.

In one embodiment, the method comprises adding sodium carbonate to the third leach liquor for the third precipitation.

In one embodiment, the method comprises saturating the third leach liquor with trisodium phosphate.

In one embodiment, the concentration of formic acid is about 1.2 mol/L.

In one embodiment, the concentration of hydrogen peroxide is about 5%.

In one embodiment, the material is a battery cathode.

In one embodiment, the material is a cathode of a battery containing lithium and iron.

In one embodiment, the material is a cathode of a lithium iron phosphate (LFP) battery.

Another aspect of the invention relates to a method for recovering one or more metals from a lithium and iron containing material, comprising: selectively leaching lithium from the material by disposing the material in a powder form in a mixture comprising formic acid at a concentration equal to or less than about 3.0 mol/L and an oxidizing reagent at a concentration that maintains an oxidative potential in the mixture; filtering the mixture to obtain a first leach liquor comprising lithium and a residue comprising iron phosphate and carbon; subjecting the first leach liquor to a first precipitation at a first selected pH and a first selected temperature to remove residual iron from the leach liquor and obtain a second leach liquor; subjecting the second leach liquor to a second precipitation at a second selected pH and a second selected temperature, wherein lithium is precipitated, and a third leach liquor is obtained.

In one embodiment, wherein the material also contains one or more other metals selected from one or more base metals, cobalt, nickel, and manganese; and the one or more other metals are precipitated from the first leach liquor during the first precipitation.

In one embodiment the method may include subjecting the third leach liquor to a third precipitation at a third selected pH and a third selected temperature, wherein lithium is precipitated.

In one embodiment first precipitation is carried out at a pH of about 9.0 and a temperature of about 60° C., wherein iron(III) hydroxide is precipitated.

In one embodiment at least one of the second selected pH and the second selected temperature is higher than the first selected pH and the first selected temperature.

In one embodiment the second precipitation is carried out at a pH of about 11.0 and a temperature of about 100° C.

In one embodiment at least one of the third selected pH and the third selected temperature is higher than the second selected pH and the second selected temperature.

In one embodiment the third precipitation is carried out at a pH of about 12.5 and a temperature of about 100° C.

In one embodiment the method may include adding a trisodium phosphate solution to the third leach liquor for the third precipitation.

In one embodiment the method may include saturating the third leach liquor with trisodium phosphate.

In one embodiment the method may comprise in situ precipitation of lithium phosphate at pH of about 11 and temperature of about 100° C.; and precipitation of lithium phosphate at pH of about 12.5 and temperature of about 100° C. using the trisodium phosphate solution.

In one embodiment the method may include adding a sodium carbonate solution to the third leach liquor for the third precipitation.

In one embodiment the method may comprise saturating the third leach liquor with sodium carbonate.

In one embodiment the method may comprise in situ precipitation of lithium phosphate at pH of about 11 and temperature of about 100° C.; and precipitation of lithium carbonate at pH of about 11 and temperature of about 100° C. using the sodium carbonate solution.

In one embodiment the concentration of formic acid is equal to or less than about 1.5 mol/L.

In various embodiments the oxidizing reagent comprises at least one of hydrogen peroxide. ozone, oxygen, oxygen enriched gas, and sodium persulfate.

In one embodiment the oxidizing reagent comprises hydrogen peroxide.

In one embodiment the concentration of hydrogen peroxide is about 5 to about 10%.

In one embodiment the mixture comprises up to about 65% pulp density of the material.

In one embodiment the material comprises a black mass.

In one embodiment the material comprises a black mass of a battery containing lithium.

In one embodiment the material comprises LFP containing material derived from a LFP battery.

### BRIEF DESCRIPTION OF THE DRAWINGS

For a greater understanding of the invention, and to show more clearly how it may be carried into effect, embodiments will be described, by way of example, with reference to the accompanying drawings, wherein:

FIGS. 1A, 1B, and 1C are flowcharts of generalized processes for recovering metals from LFP containing materials using formic acid-H₂O₂ leaching systems, according to embodiments.

FIG. 2 is a plot showing effect of formic acid concentration on leaching of metals from LFP containing materials, according to one embodiment.

FIG. 3 is a plot showing effect of hydrogen peroxide concentration on leaching of metals from LFP containing materials, according to one embodiment.

FIG. 4 is a plot showing effect of pulp density on leaching of metals from LFP containing materials, according to one embodiment.

FIG. 5 is a plot showing effect of temperature on leaching of metals from LFP containing materials, according to one embodiment.

FIG. 6 is a plot showing effect of reaction time on leaching of metals from LFP containing materials, according to one embodiment.

FIGS. 7A, 7B, and 7C are X-ray diffraction (XRD) patterns of (A) in situ precipitated Li₃PO₄, (B) Li₃PO₄ precipitated using trisodium phosphate, and (C) Li₂CO₃ precipitated using sodium carbonate, according to embodiments.

FIGS. 8A, 8B, and 8C are FE-SEM images of recovered products (A) in situ precipitated Li₃PO₄, (B) Li₃PO₄ precipitated using trisodium phosphate, and (C) Li₂CO₃ precipitated using sodium carbonate, according to embodiments.

### DETAILED DESCRIPTION OF EMBODIMENTS

According to a broad aspect, the invention provides methods for efficient, economically viable, and environmentally friendly recovering of metals, particularly lithium and iron, from materials such as but not limited to batteries. The methods are based on selective leaching of lithium from the materials.

Embodiments described herein provide sustainable methods for efficient, economically viable, and environmentally friendly recycling of material containing lithium and iron. As a non-limiting example, such material may be derived from lithium iron phosphate (LFP) batteries or black mass bearing LFP. The material may be in the form of a black mass, typically a powder or granulated particles prepared by shredding, grinding, pulverizing, etc., items containing lithium and iron, and, depending on the items, other metals. In the case of LFP batteries, the material may be black mass prepared from the battery cathodes, and other metals such as, for example, one or more base metals (e.g., copper, lead, aluminum, zinc), cobalt, nickel, and manganese may also be present. According to embodiments, metals may be recovered by selective leaching of lithium from the material with formic acid, and two or more precipitation steps in which iron and other metals are precipitated in a first precipitation at a selected pH.

Whereas formic acid has been proposed for the recycling of spent lithium-ion batteries (LIBs) based on LiCoO₂ (LCO) (Zheng at al., 2018) and LiNi_{1/3}Co_{1/3}Mn_{1/3}O₂ (Gao et al., 2017), there are drawbacks of those approaches including non-selective leaching of lithium wherein one or more other metals are present in the leachate (e.g., cobalt, nickel, manganese), high formic acid consumption, low solid to liquid ratio, the need for a high reaction temperature, incomplete recovery of lithium due to co-precipitation with the one or more other metals, and overall high cost. No previous work has explored use of formic acid for selective leaching of lithium from spent LFP batteries.

Embodiments described herein provide selective leaching of lithium from LFP containing materials or black mass comprising LFP material with low formic acid consumption, high solid to liquid ratio, a low reaction temperature, and substantially complete recovery of lithium without co-precipitation of iron or other metals. Consequently, the methods using formic acid are efficient, economically viable, and environmentally friendly.

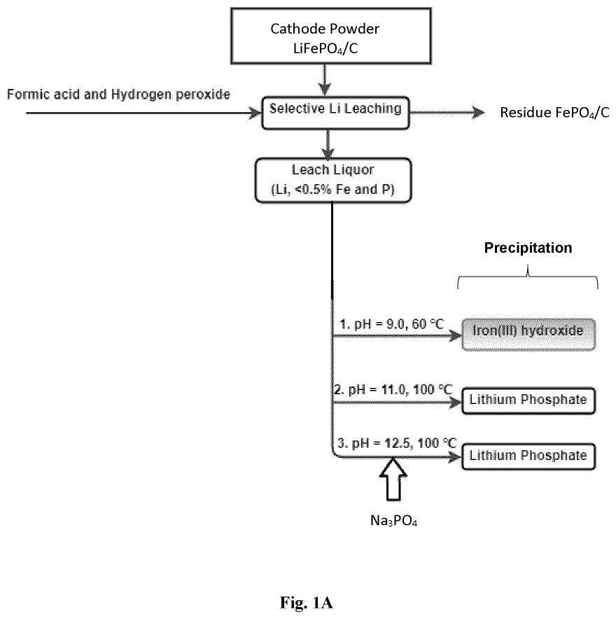

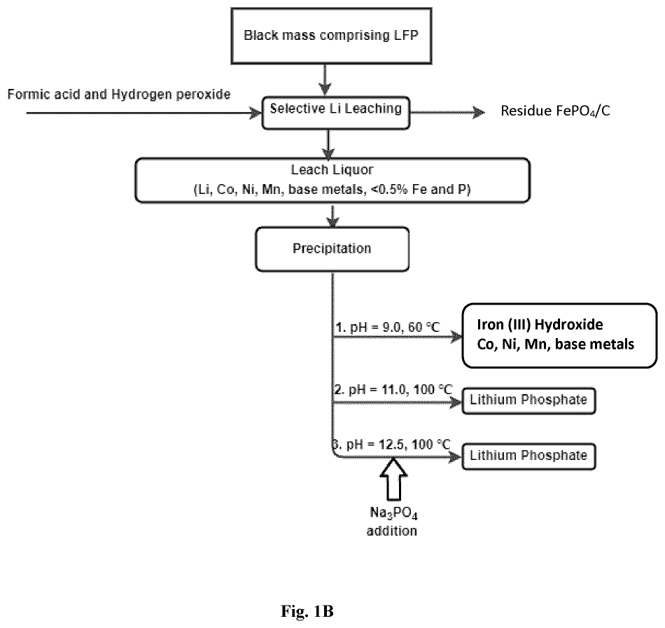

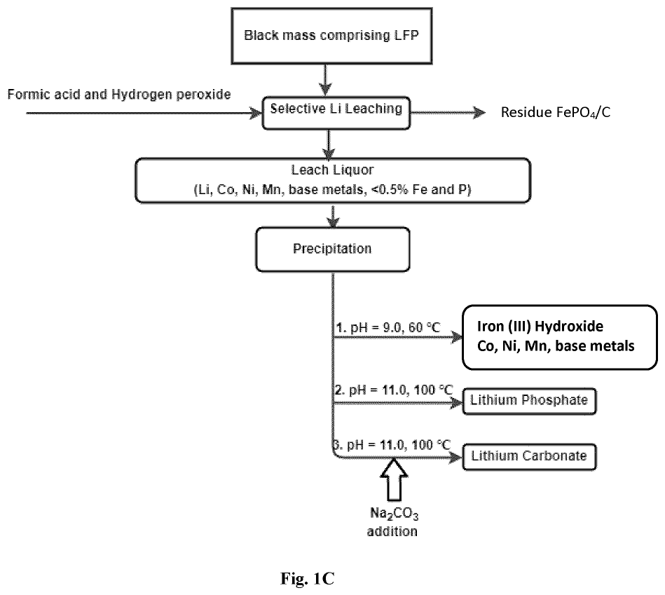

According to certain embodiments, LFP containing materials or black mass material is treated with formic acid as a leaching reagent with hydrogen peroxide or other reagent as an oxidant under controlled parameters of formic acid and hydrogen peroxide concentration, pulp density, temperature, and duration. For example, formic acid may be used at a concentration up to about 1.5 mol/L, or about 2.0 mol/L, or about 3.0 mol/L, hydrogen peroxide may be used at a concentration up to about 10%. Hydrogen peroxide improves the leaching efficiency and minimize impurities including iron to enhance selectivity of lithium leaching. Other reagents may be used as oxidants, including gases such as ozone, oxygen, and oxygen enriched gas at a flow rate of about 0.1 to 1 L/min per liter of slurry, i.e., a flow rate that maintains an oxidative potential in the mixture, sodium persulfate (Na₂S₂O₈) at a concentration up to about 10%, or other strong oxidants. Under certain conditions the hydrogen peroxide or other reagent may act as a reducing agent. For example, hydrogen peroxide acts as an oxidant in oxidizing iron (II) to iron (III), whereas it acts to reduce cobalt (III) to cobalt (II). The LFP containing materials or black mass may be added at a pulp density in which the mixture or slurry remains suitably liquid and mixable (i.e., preferably not a paste or not saturated with cathode material), e.g., up to about 60%, or about 65% pulp density. The process may be carried out at a temperature range of about 30-70° C., or about 5-100° C., or greater, and for duration ranges of at least about 10 min, wherein a pregnant leach liquor is produced that includes lithium. Depending on the material (LFP containing material, black mass) being processed, the pregnant leach liquor may also include trace amounts of iron, and other metals that may be present in the material (e.g., one or more base metals, cobalt, nickel, and manganese), and a residue may be produced that includes iron phosphate and carbon, as shown in the embodiments of FIGS. 1A, 1B, and 1C.

In one embodiment, leaching conditions that produce favourable results, that is, selective leaching of lithium, include formic acid at a concentration equal to or less than about 1.5 mol/L, e.g., about 1.0 to 1.5 mol/L, or 1.0 to 1.2 mol/L, hydrogen peroxide at a concentration of about 5%, a pulp density of about 10-20%, and temperature of about 30-50° C.

In another embodiment, leaching conditions may include formic acid at a concentration of about 1.0 to 1.2 mol/L, hydrogen peroxide at a concentration of about 5%, a pulp density of about 10%, and temperature of about 30° C.

In other embodiments, leaching conditions may include formic acid at a concentration of about 0.5 to 1.5 mol/L, hydrogen peroxide at a concentration of about 0.2 to 10%, a pulp density of about 10 to 40%, and temperature of about 30 to 50° C.

In implementations where the material includes lithium and other metals, such as, for example, one or more of the above-mentioned one or more base metals, cobalt, nickel, and manganese, the pregnant leach liquor may be subjected to an initial precipitation carried out at pH of about 2 to about 10.5, or about 2 to about 9, and temperature of about 50° C. to about 70° C. Under these conditions there is little or no precipitation of lithium, and substantially complete precipitation of any of the one or more base metals, cobalt, nickel, and manganese, as well as residual iron, if present, as shown in the embodiments of FIGS. 1B and 1C.

According to embodiments, precipitation of lithium as Li₃PO₄ or Li₂CO₃ from the pregnant leach liquor may be carried out in one or more steps under conditions of elevated pH, e.g., pH 10-13, and elevated temperature, e.g., up to about 100° C. In some embodiments, precipitation of Li₃PO₄ or Li₂CO₃ is carried out in two steps, e.g., firstly, in situ precipitation of Li₃PO₄ at pH of about 11 and temperature of about 100° C., and secondly at an elevated pH of about 12.5 at about 100° C. using a Na₃PO₄ solution, or at pH of about 11 and temperature of about 100° C. using a Na₂CO₃ solution. In some embodiments, the Na₃PO₄ solution or the Na₂CO₃ solution may be added at a high molar ratio (i.e., at excessive amounts, greater than the required stoichiometric amount, e.g., at 1 mol/L or 2 mol/L) or they may be saturated solutions. As non-limiting examples, Na₃PO₄ may be added at a PO₄²⁻:Li⁺ molar ratio of 1.33:3, and Na₂CO₃ may be added at a Na:Li molar ratio of 1:1. According to embodiments, mass balance may indicate >99.5% recovery of lithium with high purity products.

Thus, embodiments described herein may include selective leaching with in situ precipitation of Li₃PO₄ in a first step followed by precipitation of remaining lithium as Li₃PO₄ or Li₂CO₃ using a high molar ratio solution or saturated solution of trisodium phosphate or sodium carbonate, respectively. The resulting liquor is rich in sodium and formate ions and, e.g., may be recycled as sodium oxalate to reduce the environmental load.

As noted above, LFP material subjected to methods for recovering lithium according to the embodiments may be in the form of a black mass. For recovering one or more metals including lithium from an LFP battery, the black mass may be obtained by disassembling a LFP battery to obtain the cathode, removing metal (e.g., aluminum) foil from the cathode, and grinding, pulverizing, etc. the cathode to a powdered, particulate, or granular, etc. form (hereinafter referred to as “powder”). Although methods are provided herein for obtaining LFP battery cathode powder, the powder (i.e., black mass) may be procured from facilities and operations that process spent LFP batteries.

Embodiments significantly improve the recovery of pure metal products from LFP battery cathodes, with economic and environmental benefits through recyclability and recirculation of the reagents used. The methods may be scaled up and applied to industrial processes.

The invention will be further described by way of the following non-limiting Examples.

### EXAMPLES

### Materials

Spent LFP batteries with LiFePO₄/C as cathode material were procured from a local industry. Formic acid (HCOOH), hydrogen peroxide (50 wt % H₂O₂), sodium hydroxide (NaOH), trisodium phosphate (Na₃PO₄·12H₂O), and sodium carbonate (Na₂CO₃) were purchased from Sigma Aldrich, USA. Deionized water was used to prepare solutions. Sodium hydroxide solution was used to adjust the pH of leach liquor.

### Pre-Treatment of Spent LFP Batteries

Spent LFP batteries were initially dipped in 1.0 mol/L sodium chloride solution for complete discharging to avoid short circuiting. Afterwards, batteries were dismantled in order to separate anode (coated on copper foil) and cathode (coated on aluminum foil). The cathode material was separated from aluminum foil by maintaining cathodes in a solution of 1.5% sodium hydroxide for 0.5 h under ultrasound using a VWR® Ultrasonic Cleaner (VWR International, Mississauga, Ontario) with 10% (w/v) pulp density. The cathode material was then washed with deionized water and dried in an oven at 60° C. for 48 h. The dried cathode material was crushed and sieved through 74 μm sieve (200 US Mesh) to obtain a fine powder (i.e., black mass). A definite amount of cathode powder was digested in a definite volume of aqua regia and the resulting solution was analyzed for elements concentration using inductively coupled plasma-optical emission spectrometry (ICP-OES). The major elemental contents (wt %) were found to be 32.50% Fe, 4.35% Li, and 18.05% P. For black mass derived from LFP battery cathodes, other metals such as cobalt, nickel, and manganese may be present at about 5 wt % or less.

### General Procedure

FIGS. 1A, 1B, and 1C are flowcharts showing generalized procedures, according to embodiments for selective leaching of lithium, wherein three or more precipitation steps are shown and exemplary conditions of pH and temperature are given.

All leaching experiments were performed in a 500 mL round bottom flask over a magnetic stirrer (500 rpm speed) with a temperature controlling probe using formic acid as a lixiviant and hydrogen peroxide as an oxidant for the desired time period. The flask was fitted with a condenser to avoid volume loss via evaporation at high temperatures. Once the reaction was complete, the flask was immediately removed and the contents subjected to filtration. The metals content was then checked in the liquor. The residues left were washed with deionized water and then placed in an oven for drying at 60° C. for 48 h. After analyzing the metals concentration, the leaching efficiency (LE) of each metal was calculated using the following formula

$$L E = \frac{C \times V}{m \times w \%} \times 100$$

where C, V, m, and w % are the metal concentrations in leach liquor, volume of leach liquor, mass of cathode powder, and mass fraction of metal in cathode powder, respectively. All experiments were done in triplicate and the standard deviation was found to be ±5% throughout the study.

### Characterization Techniques

The concentration of elements in the digested and leach liquors were analyzed using microwave plasma atomic emission spectroscopy (MP-AES, Agilent 4200) and ICP-OES techniques. The spent cathode powder, residue after leaching, and recovered lithium products were characterized through powder X-ray diffraction (XRD) using X'Pert Pro Philips powder diffractometer employing Cu-Ku radiation (λ=1.54 Å). Surface morphologies were also studied with a field emission scanning electron microscope (FE-SEM, Quanta 650).

### Effect of Formic Acid Concentration

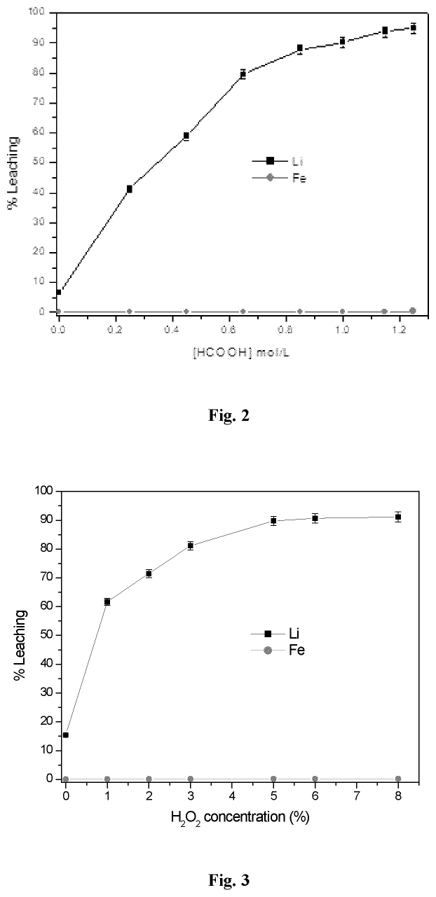

The formic acid concentration was varied from 0.25 to 1.25 mol/L to observe its effect on the selective leaching of lithium. The other experimental conditions, i.e., pulp density (10% w/v), H₂O₂ concentration (5% v/v), temperature (T=50° C.), and reaction time (t=1 h) were kept constant throughout the experiment. As shown in FIG. 2, lithium was selectively leached at all formic acid concentrations and leaching efficiency increased from 41.29% to 95.17% with increase in formic acid concentration with <1% leaching efficiency for iron. A formic acid concentration of 1.0 mol/L with 90% lithium leaching efficiency was selected for further study.

### Effect of Hydrogen Peroxide Concentration

The amount of hydrogen peroxide added initially to the reaction system significantly affected leaching efficiency. It is clear from FIG. 3 that lithium was selectively leached in the investigated range of H₂O₂ concentration and leaching efficiency increases with increase in H₂O₂ concentration. A H₂O₂ concentration of 5% (v/v) with 1.0 mol/L HCOOH, 10% (w/v) pulp density, T=50° C., and t=1 h resulted in 89.77% Li leaching efficiency. The further rise in H₂O₂ concentration did not show any observable change in leaching efficiency due to significant oxidation of iron and possible decomposition of H₂O₂ at high concentration. A H₂O₂ concentration of 5% (v/v) was selected for further studies.

### Effect of Pulp Density

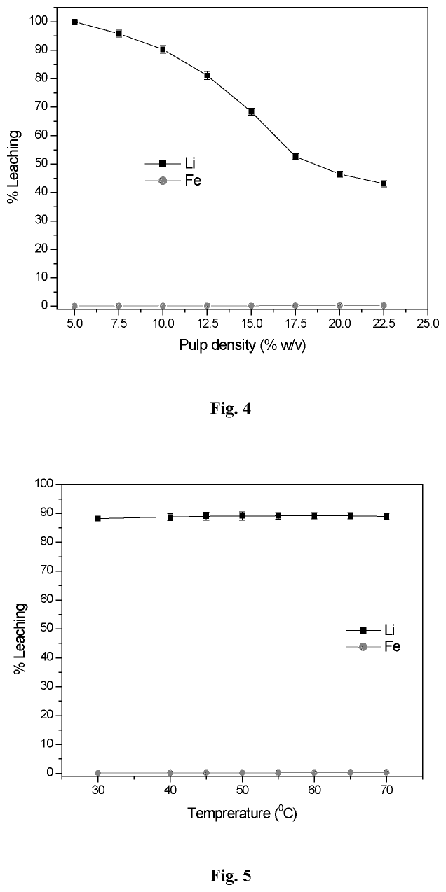

FIG. 4 shows the effect of pulp density (%, w/v) on the selective leaching efficiency of lithium. The amount of cathode powder was varied from 5.0 g to 22.5 g in 100 mL of the lixiviant (1.0 mol/L HCOOH) containing 5% H₂O₂. The reaction was carried out at 50° C. for 1 hour. The leaching efficiency decreased from 100% to 43% with rise in pulp density from 5% to 22.5%, respectively. A pulp density of 10% was considered as the optimum parameter to study the effect of time and temperature on leaching efficiency.

### Effect of Temperature

The reaction temperature was varied from 30° C. to 70° C. using 1.0 mol/L HCOOH, 5% H₂O₂, and 10% pulp density for one hour to observe change in leaching efficiency of lithium and iron. FIG. 5 shows that there was no significant change in leaching efficiency of metals in the investigated range of temperature. Lithium was selectively and quantitatively (≥89%) leached from the solution at all temperatures, and it is expected that the temperature range could be wider. All other experiments were carried out at 50° C. and the reaction can also be performed at low temperature for industrial application in order to save cost for heat energy. For example, it is expected that good leaching efficiency can be obtained at room temperature, providing significant energy and cost savings.

### Effect of Reaction Time

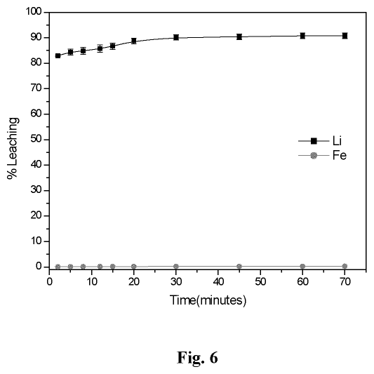

A variation in reaction time from 2 min to 70 min at optimized leaching conditions, i.e., 1.0 mol/L HCOOH, 5% H₂O₂, 10% pulp density and 50° C. temperature was done to study time effect. As shown in FIG. 6, lithium leaching efficiency increased to 89.43% in 20 min and thereafter attained constant value with 1-2% increase up to 70 min. However, Fe did not show <0.5% leaching efficiency in the entire range of study. Based on the results of studied leaching parameters, 30 min reaction time using 10% pulp density, 1.0 mol/L HCOOH with 5% H₂O₂, at 30° C. were found to be effective conditions for the selective recovery of lithium from spent LFP battery cathode powder.

Recovery of Lithium from Pregnant Leach Liquor

The above-noted optimized conditions for selective leaching of lithium were used to produce bulk amounts of leach liquor for recovery of lithium products. Those leaching conditions, i.e., 10% pulp density, 1.0 mol/L HCOOH with 5% H₂O₂, at 30° C. for 0.5 h were used to produce 500 mL of leach liquor. It is to be understood that these are suggested optimized conditions, as it will be readily apparent to those of ordinary skill that one or more of the parameters may be varied and the same or better results obtained. Accordingly, the suggested optimized conditions are an embodiment and the invention is not limited thereto.

The concentrations of Li, Fe, and P were found to be 3950 mg/L, 101 mg/L and 381 mg/L, respectively, in the pregnant leach liquor. Iron was precipitated as iron hydroxide at pH=9.0 and 60° C. temperature. The leach liquor was filtered and analyzed for its metal contents. The pH was raised to 11 using NaOH solution and lithium was in situ precipitated as Li₃PO₄ at 100° C. by the leached phosphate present in the reaction system. White precipitates thus obtained were filtered, washed with hot deionized water and dried in an oven at 80° C. for 24 h. The leach liquor remaining after filtration of precipitates was subjected to analysis and lithium concentration was found to be 3704 mg/L. The filtrate remaining was adjusted to pH 12.5 by adding NaOH solution. Lithium precipitation was accelerated by adding a small amount of solid Na₃PO₄ followed by 1.0 mol/L Na₃PO₄ solution and keeping PO₄³⁻/Li⁺ molar ratio 1.33:3 (Song et al., 2018) with continuous stirring at 100° C. for satisfactory precipitation results (FIG. 5) (Cai et al., 2014; Song, 2018). White precipitates thus obtained were filtered, washed with hot deionized water and dried in an oven at 60° C. for 24 h. Approximately >99.5% of Li was precipitated at the end of the reaction. The concentrations of lithium and iron at different stages of the process are shown in Table 1.

TABLE 1
Concentrations of Li and Fe at different stages of the process

| Stage of Process | Li (mg/L) | Fe (mg/L) |
|---|---|---|
| Pregnant leach liquor | 3950 | 101 |
| After Fe precipitation | 3944 | — |
| After in situ Li₃PO₄ precipitation | 3704 | — |
| After Li₃PO₄ precipitation | 9 | — |

In another embodiment the leach solution was processed according to the above procedures up to the second precipitation and then saturated Na₂CO₃ was added and the third precipitation was carried out at the pH and temperature used in the second precipitation to obtain lithium carbonate.

### Characterization of Recovered Products

The recovered lithium phosphate and lithium carbonate were characterized using an XRD technique and purity was evaluated using MP-AES analysis of the solution of product in 5% nitric acid.

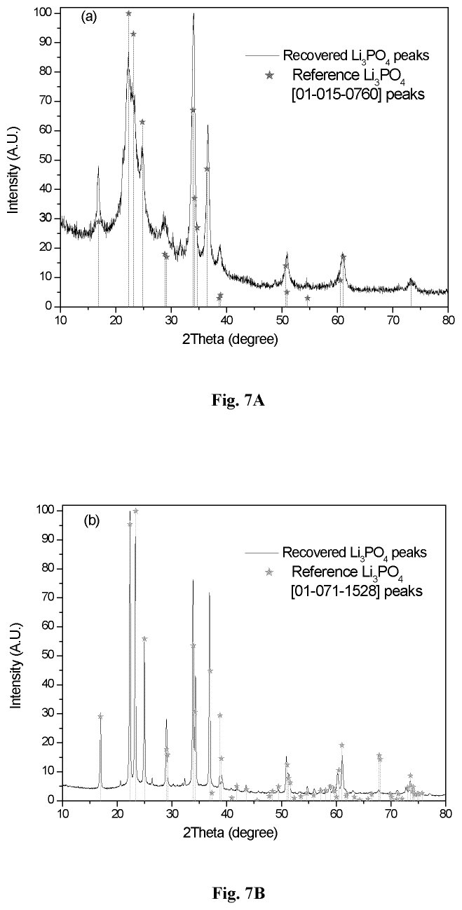

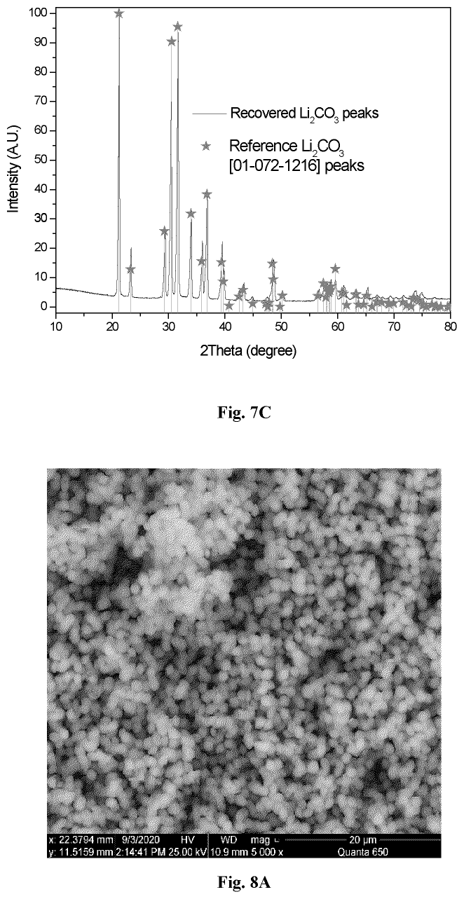

FIGS. 7A, 7B, and 7C are XRD spectra of in situ precipitated lithium phosphate, lithium phosphate precipitated using sodium phosphate as precipitating agent, and lithium carbonate precipitated using sodium carbonate as precipitating agent, respectively, obtained from processing of pregnant leach liquor. The diffraction peaks of the recovered products are in good agreement with their respective reference peaks and confirm the purity of recovered products. The reference peaks corresponding to each product are plotted as bar graph lines.

XRD pattern of in situ precipitated Li₃PO₄ (FIG. 7A) is indexed to the orthorhombic crystal system with lattice parameters a=6.1147 Å, b=10.4750 Å, c=4.9228 Å (JCPDS card number: 01-015-0760). XRD of lithium phosphate precipitated using sodium phosphate (FIG. 7B) corresponds to orthorhombic phase with lattice parameters a=6.1150 Å, b=5.2394 Å, c=4.8554 Å (JCPDS card number: 00-015-0701). The crystallite sizes of recovered products were calculated using Debye-Scherrer equation: D=0.9λ/βCos θ, where λ is wavelength of X-ray beam, β is line broadening measured at half-height (FWHM) of the most intense peak and θ is the Bragg angle and found to be 13.18 nm, and 52.86 nm for in situ precipitated Li₃PO₄ and Li₃PO₄ precipitated using sodium phosphate, respectively. XRD pattern of precipitated Li₂CO₃ (FIG. 7C) was indexed to the monoclinic crystal system with lattice parameters a=8.3900 Å, b=5.0000 Å, c=6.2100 Å (JCPDS card number: 01-072-1216). The purity of products was found to be >99.5% containing less than 0.1 ppm iron.

### FE-SEM Analysis

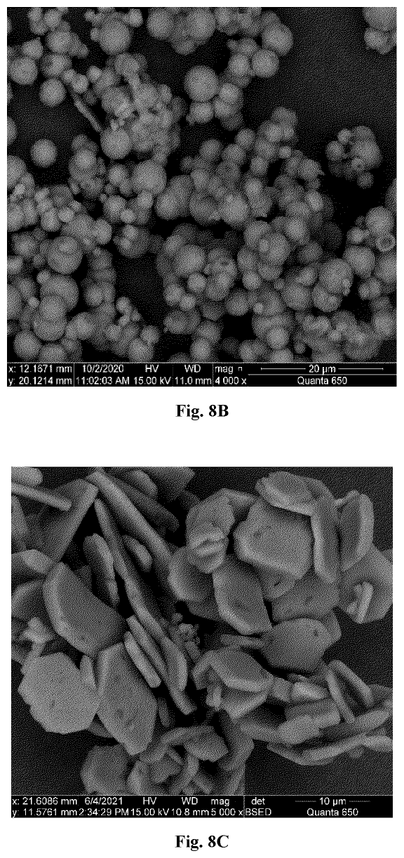

The morphology of recovered products was investigated using FE-SEM technique and is presented in FIGS. 8A, 8B, and 8C. FE-SEM exhibits a spherical shape for particles with a small degree of agglomeration for the recovered lithium phosphate. The lithium phosphate precipitated in situ was found to have smaller particle size (FIG. 8A) when compared to the lithium phosphate precipitated using trisodium phosphate (FIG. 8B). However, lithium carbonate has irregular shape with few hexagonal particles and was found to have bigger size particles in comparison to lithium phosphate (FIG. 8C).

### Reagent Consumption

The reagent consumption, that is, the minimum amounts of the reagents required to recover substantially 100% of the lithium from LFP battery cathodes, are given in Table 2.

TABLE 2
Reagent consumption per mole of lithium recovered

| | Amount |
|---|---|
| Reagent | (moles) |
| Lixiviant (1.0 mol/L formic acid) | 1.76 |
| Hydrogen peroxide 50 wt %, (5% used for reaction) | 1.55 |
| Na₃PO₄•12H₂O (1.0 mol/L solution) | 0.45 |
| Na₂CO₃ saturated solution | 0.43 |

However, for optimal results excessive (i.e., greater than the required stoichiometric amount) or saturated Na₂CO₃ solution may be used to obtain lithium carbonate from leach liquor.

### Further Embodiments

It is expected that methods described herein may be adapted for recovering other metals, for example platinum groups metals, from materials such as printed circuit boards and automobile catalysts, and recovering copper from low-grade copper ore, etc.

### EQUIVALENTS

It will be appreciated that modifications may be made to the embodiments described herein without departing from the scope of the invention. Accordingly, the invention should not be limited by the specific embodiments set forth but should be given the broadest interpretation consistent with the teachings of the description as a whole.

### REFERENCES

Bian, D.; Sun, Y.; Li, S.; Tian, Y.; Yang, Z.; Fan, X.; Zhang, W. A Novel Process to Recycle Spent LiFePO₄ for Synthesizing LiFePO₄/C Hierarchical Microflowers. Electrochim. Acta 2016, 190, 134-140. https://doi.org/10.1016/j.electacta.2015.12.114.
Byeon, P.; Bae, H. B.; Chung, H. S.; Lee, S. G.; Kim, J. G.; Lee, H. J.; Choi, J. W.; Chung, S. Y. Atomic-Scale Observation of LiFePO₄ and LiCoO₂ Dissolution Behavior in Aqueous Solutions. Adv. Funct. Mater. 2018, 28 (45), 1804564.
Cai, G.; Fung, K. Y.; Ng, K. M.; Wibowo, C. Process Development for the Recycle of Spent Lithium Ion Batteries by Chemical Precipitation. Ind. Eng. Chem. Res. 2014, 53 (47), 18245-18259. https://doi.org/10.1021/ie5025326.
Gao, W., et al. Lithium Carbonate Recovery from Cathode Scrap of Spent Lithium-Ion Battery: A Closed-Loop Process. Environ. Sci. Technol. 2017, 51, 1662-1669. DOI: 10.1021/acs.est.6b03320.(14)
Goodenough, J. B.; Kim, Y. Challenges for Rechargeable Li Batteries. Chem. Mater. 2010, 22 (3), 587-603. https://doi.org/10.1021/cm901452z.
He, K.; Zhang, Z. Y.; Zhang, F. S. A Green Process for Phosphorus Recovery from Spent LiFePO₄ Batteries by Transformation of Delithiated LiFePO₄ Crystal into NaFeS₂. J. Hazard. Mater. 2020, 395, 122614. https://doi.org/10.1016/j.jhazmat.2020.122614.
Jiang, L. G.; Liang, B.; Xue, Q.; Yin, C. W. Characterization of Phosphorus Leaching from Phosphate Waste Rock in the Xiangxi River Watershed, Three Gorges Reservoir, China. Chemosphere 2016, 150, 130-138. https://doi.org/10.1016/j.chemosphere.2016.02.008.
Kavanagh, L.; Keohane, J.; Cabellos, G. G.; Lloyd, A.; Cleary, J. Global Lithium Sources-Industrial Use and Future in the Electric Vehicle Industry: A Review. Resources 2018, 7 (3), 1-29. https://doi.org/10.3390/resources7030057.
Li, H.; Xing, S.; Liu, Y.; Li, F.; Guo, H.; Kuang, G. Recovery of Lithium, Iron, and Phosphorus from Spent LiFePO₄ Batteries Using Stoichiometric Sulfuric Acid Leaching System. ACS Sustain. Chem. Eng. 2017, 5 (9), 8017-8024. https://doi.org/10.1021/acssuschemeng.7b01594.
Li, Z.; Liu, D. F.; Xiong, J.; He, L.; Zhao, Z.; Wang, D. Selective Recovery of Lithium and Iron Phosphate/Carbon from Spent Lithium Iron Phosphate Cathode Material by Anionic Membrane Slurry Electrolysis. Waste Manag. 2020, 107, 1-8. https://doi.org/10.1016/j.wasman.2020.03.017.
Shin, E. J.; Kim, S.; Noh, J. K.; Byun, D.; Chung, K. Y.; Kim, H. S.; Cho, B. W. A Green Recycling Process Designed for LiFePO₄ Cathode Materials for Li-Ion Batteries. J. Mater. Chem. A 2015, 3 (21), 11493-11502. https://doi.org/10.1039/c5ta02540k.
Song, Y.; Zhao, Z. Recovery of Lithium from Spent Lithium-Ion Batteries Using Precipitation and Electrodialysis Techniques. Sep. Purif Technol. 2018, 206, 335-342. https://doi.org/10.1016/j.seppur.2018.06.022.
Song, Y. J. Recovery of Lithium as Li₃PO₄ from Waste Water in a LIB Recycling Process. J. Korean Inst. Met. Mater. 2018, 56 (10), 755-762. https://doi.org/10.3365/KJMM.2018.56.10.755.
Yang, Y.; Meng, X.; Cao, H.; Lin, X.; Liu, C.; Sun, Y.; Zhang, Y.; Sun, Z. Selective Recovery of Lithium from Spent Lithium Iron Phosphate Batteries: A Sustainable Process. Green Chem. 2018, 20 (13), 3121-3133. https://doi.org/10.1039/c7gc03376a.
Zheng, Y.; Song, W.; Mo, W. T.; Zhou, L.; Liu, J. W. Lithium Fluoride Recovery from Cathode Material of Spent Lithium-Ion Battery. RSC Adv. 2018, 8 (16), 8990-8998. https://doi.org/10.1039/c8ra00061a.

1. A method for recovering one or more metals from a lithium and iron containing material, comprising:
selectively leaching lithium from the material by disposing the material in a powder form in a mixture comprising formic acid at a concentration equal to or less than about 3.0 mol/L and an oxidizing reagent at a concentration that maintains an oxidative potential in the mixture;
filtering the mixture to obtain a first leach liquor comprising lithium and a residue comprising iron phosphate and carbon;
subjecting the first leach liquor to a first precipitation at a first selected pH and a first selected temperature to remove residual iron from the leach liquor and obtain a second leach liquor;
subjecting the second leach liquor to a second precipitation at a second selected pH and a second selected temperature, wherein lithium is precipitated, and a third leach liquor is obtained.

2. The method of claim 1, wherein the material also contains one or more other metals selected from one or more base metals, cobalt, nickel, and manganese; and
the one or more other metals are precipitated from the first leach liquor during the first precipitation.

3. The method of claim 1, comprising subjecting the third leach liquor to a third precipitation at a third selected pH and a third selected temperature, wherein lithium is precipitated.

4. The method of claim 1, wherein the first precipitation is carried out at a pH of about 9.0 and a temperature of about 60° C., wherein iron(III) hydroxide is precipitated.

5. The method of claim 1, wherein at least one of the second selected pH and the second selected temperature is higher than the first selected pH and the first selected temperature.

6. The method of claim 1, wherein the second precipitation is carried out at a pH of about 11.0 and a temperature of about 100° C.

7. The method of claim 1, wherein at least one of the third selected pH and the third selected temperature is higher than the second selected pH and the second selected temperature.

8. The method of claim 3, wherein the third precipitation is carried out at a pH of about 12.5 and a temperature of about 100° C.

9. The method of claim 3, comprising adding a trisodium phosphate solution to the third leach liquor for the third precipitation.

10. The method of claim 9, comprising saturating the third leach liquor with trisodium phosphate.

11. The method of claim 9, comprising:
in situ precipitation of lithium phosphate at pH of about 11 and temperature of about 100° C.; and
precipitation of lithium phosphate at pH of about 12.5 and temperature of about 100° C. using the trisodium phosphate solution.

12. The method of claim 3, comprising adding a sodium carbonate solution to the third leach liquor for the third precipitation.

13. The method of claim 12, comprising saturating the third leach liquor with sodium carbonate.

14. The method of claim 12, comprising:
in situ precipitation of lithium phosphate at pH of about 11 and temperature of about 100° C.; and
precipitation of lithium carbonate at pH of about 11 and temperature of about 100° C. using the sodium carbonate solution.

15. The method of claim 1, wherein the concentration of formic acid is equal to or less than about 1.5 mol/L.

16. The method of claim 1, wherein the oxidizing reagent comprises at least one of hydrogen peroxide. ozone, oxygen, oxygen enriched gas, and sodium persulfate.

17. The method of claim 1, wherein the oxidizing reagent comprises hydrogen peroxide.

18. The method of claim 17, wherein the concentration of hydrogen peroxide is about 5 to about 10%.

19. The method of claim 1, wherein the mixture comprises up to about 65% pulp density of the material.

20. The method of claim 1, wherein the material is a black mass.

21. The method of claim 1, wherein the material is a black mass of a battery containing lithium.

22. The method of claim 1, wherein the material comprises LFP containing material derived from a LFP battery.
